(19) United States
(12) Patent Application Publication
(10) Pub. No.: US 2008/0177596 A1
(43) Pub. Date: Jul. 24, 2008

(54) PERSONAL REFERRAL ONLINE ADVERTISEMENT SYSTEM

(76) Inventor: Hongtao Austin Yu, Rolling Hills, CA (US)

Correspondence Address: SMITH-HILL AND BEDELL, P.C., 16100 NW CORNELL ROAD, SUITE 220, BEAVERTON, OR, 97006, US

(21) Appl. No.: 11/969,081

(22) Filed: Jan. 3, 2008

Related U.S. Application Data
(60) Provisional application No. 60/886,237, filed on Jan. 23, 2007.

(51) Int. Cl. G06Q 10/00; G06F 17/30

(52) U.S. Cl. 705/7

(57) ABSTRACT

An advertising referral service operates a referral service website including a listing agent interface that allows a listing agent to offer ads for placing on websites and a hosting agent interface that allows a hosting agent to select an ad offered by the listing agent and place the selected ad on the hosting agent's website. When a visitor to the hosting agent's website activates the listing agent's ad, the referral service records a credit entry to the hosting agent and a debit entry to the listing agent. The referral service reports the credit and debit entries to the hosting agent and to the listing agent.

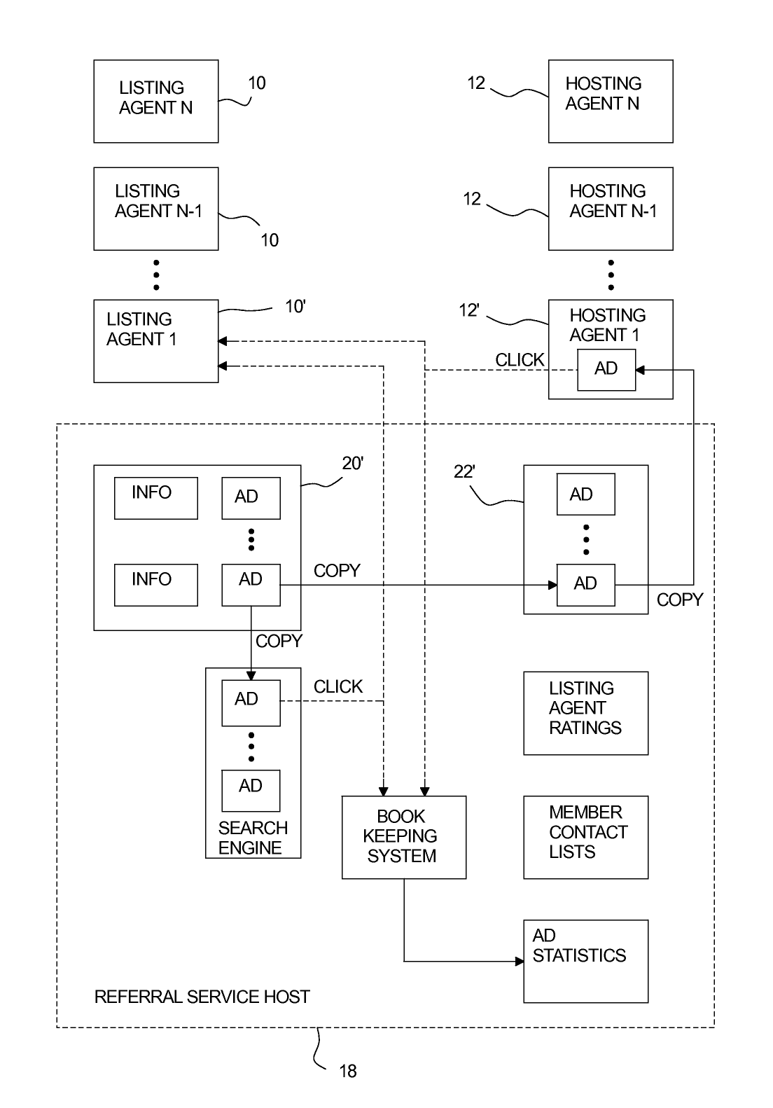

### CROSS-REFERENCE TO RELATED APPLICATION

This application claims benefit of U.S. Provisional Application No. 60/886,237 filed Jan. 23, 2007, the entire disclosure of which is incorporated herein by reference for all purposes.

### BACKGROUND OF THE INVENTION

This invention relates to a personal referral online advertisement system.

It is well known that a web page that is displayed on a user's computer may include an advertisement (herein referred to for brevity as an ad) in which a hypertext link is embedded. When the user activates, or clicks on, the ad, the user's web browser is redirected in accordance with information that is encoded in the hypertext link. The hypertext link may include a URL, in which case when the link is activated the browser is redirected to another website, typically to a website operated by the advertiser. The URL may be encoded with other information.

A simple model of online advertising and sales involves an advertiser who maintains a website containing one or more web pages including ads and a search engine that provides a mechanism by which a potential customer for the advertiser's products will visit the advertiser's website. Suppose, for example, that the customer is seeking information regarding digital cameras and enters the search term “digital camera” in the search field of the search engine. The search result may contain links to the websites of retailers that advertise digital cameras for sale. The customer clicks on one of those links and thereby visits an advertiser's website. The website will normally contain ads for digital cameras, and should the customer click on an ad for a particular camera the customer's computer transmits a URL that includes the Internet address of a web page containing information regarding that camera and including a control that allows the customer to commence a purchase and sale transaction involving the camera. The URL of the link contained in the search result may be encoded with information that allows the search engine to count the number of times that users of the search engine click through a search result to the advertiser's website. The operator of the search engine bills the advertiser periodically based on the number of clicks through to the advertiser's website.

A slightly more complex model involves an entity that refers customers to the advertiser's website. Such an entity may operate a website that contains reviews of various products. In the example discussed above, the search result may include a link to a website that contains reviews of digital cameras and ads for the cameras featured in the reviews. The customer may click on the link to the reviewer's website and click on an ad that redirects the customer to the advertiser's website. In this case, the advertiser may pay the reviewer for clicks through and the reviewer may pay the search engine for clicks through.

Entities that operate search engines may enter into arrangements by which advertisers bid for rights to particular popular keywords. For example, a search engine operator might ask advertisers to bid on the search term “digital camera,” and the search result then places a high bidder ahead of a low bidder in the list of search results returned by a search on the term “digital camera.”

Internet advertising has a relatively low transaction completion rate: relatively few potential purchasers who click on a retailer's ad ultimately purchase the retailer's product. One possible reason for this low transaction completion rate is that the advertised product is not recommended in a way that is considered by the potential customer as being worthy of recognition. The customer knows that the relationship between the reviewer and the advertiser is purely commercial and that the reviewer does not endorse the retailer's product. Even if the reviewer recommended the retailer's product, in general the customer has no reason to trust the reviewer's recommendation.

In addition, the current Internet advertising model is not well suited to advertising and sale of services, such as those provided by accountants, attorneys and photographers. Potential purchasers of services may rely heavily on personal recommendations in selecting a service provider and the current search engines do not provide an effective mechanism for collecting and providing information regarding service providers.

### SUMMARY OF THE INVENTION

In accordance with a first aspect of the invention there is provided a method of managing advertising on an Internet website, wherein a referral service operates a referral service website including a listing agent interface that allows a listing agent to offer ads for placing on websites and a hosting agent interface that allows a hosting agent to select an ad offered by the listing agent and place the selected ad on the hosting agent's website, when a visitor to the hosting agent's website activates the listing agent's ad, the referral service records a credit entry to the hosting agent and a debit entry to the listing agent, the referral service reports the credit and debit entries to the hosting agent and to the listing agent.

In accordance with a second aspect of the invention there is provided a method of managing advertising on an Internet website by a referral service association including listing agent members and hosting agent members, wherein the listing agent members and the hosting agent members operate respective public websites, the referral service operates a referral service host including listing agent pages allocated to the listing agents respectively, a listing agent uses the allocated listing agent page to offer ads for placing on hosting agent websites, a hosting agent selects an ad from the listing agent page and places the selected ad on the hosting agent's public website, when a visitor to the hosting agent's public website activates the listing agent's ad, the visitor is redirected to the listing agent's public website and the referral service records a credit entry to the hosting agent and a debit entry to the listing agent, the referral service reports the credit and debit entries to the hosting agent and to the listing agent.

In accordance with a third aspect of the invention there is provided a method of managing referrals by a referral service association including listing agent members and hosting agent members, wherein the listing agent members operate respective public websites though which each listing agent member offers to enter into contracts for providing goods or services, the hosting agent members may indicate approval of a listing agent member, the referral service operates a website with a search engine interface whereby a visitor may enter a query seeking goods or services offered by one or more listing agents, and in response to a query, the search engine returns a search result in which listing agents that meet the query are identified in order of precedence based on approval by the hosting agent members.

### BRIEF DESCRIPTION OF THE DRAWINGS

For a better understanding of the invention, and to show how the same may be carried into effect, reference will now be made, by way of example, to the accompanying drawings, the single FIGURE of which is a block diagram illustrating operation of an advertising model based on a referral service.

### DETAILED DESCRIPTION

Referring to the drawing, a referral service has members, each of which is a listing agent and/or a hosting agent. The listing agents and the hosting agents maintain respective public websites 10, 12. Continuing the previous example, one of the listing agents is a camera retailer whose website 10′ contains ads for various cameras, lenses and other accessories. The camera retailer's website 10′ also includes an online store that allows visitors to the website to place orders for the products that are advertised on the website. One of the hosting agents is a photographer whose website 12′ includes pages containing images of photographs she has taken and may also contain articles describing her experiences, places she has visited and the equipment she uses.

The referral service operates a computer that hosts a referral service website 18 containing listing agent pages and hosting agent pages. Only the listing agent page 20′ of the camera retailer and the hosting agent page 22′ of the photographer are shown in the drawing. The listing agent pages and the hosting agent pages are distinct from the public websites of the listing and hosting agents and are not accessible on the Internet except through a secure login to the referral service website. A listing agent page is a menu of ads that the listing agent offers to hosting agents for display on the hosting agents' websites. Thus, the camera retailer's listing agent page 20′ contains images of ads for cameras, lenses and other accessories and also contain associated information. The information that is associated with an ad typically includes advertising rates, such as the amount that the camera retailer, as listing agent, will pay a hosting agent each time a visitor to the hosting agent's website clicks through the ad to the listing agent's website, and payment terms. The information, particularly in the case of an ad for a specific product as opposed to a general ad for a store, might also include information regarding special promotions offered by the manufacturer of the product and information regarding advertising campaigns being run by the manufacturer.

The ad images that are displayed on the listing agents' pages have hyperlinks embedded therein but the hyperlinks are not active, in that clicking on an ad does not redirect a viewer to the listing agent's public website although it might redirect the viewer to the information associated with the ad.

The photographer's hosting agent page 22′ contains ads that the hosting agent has selected from one or more listing agent pages for potential display on her website 12′.

The camera retailer's listing agent page 20′ on the referral service website might contain ads for the online store as well as ads for the various products offered by the listing agent through the online store. Suppose that the photographer bought a camera from the listing agent's online store and found that the camera worked particularly well and that the service provided by the camera store was particularly good. The photographer decides that visitors to her website might find this information useful, and publishes an account of her experiences on her public website 12′. The photographer, as hosting agent, logs on to the referral service website and navigates to the camera store's listing agent page 20′. The photographer scrolls down the listing agent page and may select two ads for the online camera store and three ads for the particular model of camera that she bought. Each ad is associated with a URL that identifies the listing agent and specifies the address of the ultimate destination to which a visitor should be directed (typically a page on the camera retailer's public website 10′). The photographer copies the selected ads to her hosting agent page 22′ by using a conventional drag and drop or copy and paste procedure, or by using the tag-and-act interface described in Provisional Application No. 60/887,179, the entire disclosure of which is hereby incorporated by reference herein for all purposes. When an ad is copied to the hosting agent page, the URL associated with the ad is modified by adding information identifying the hosting agent and (in the case of the tag-and-act interface) the tag associated with the ad object is similarly modified. The photographer may then decide that she does to want to include all the ads on her website, so she selects one ad for the store and one ad for the camera model, copies these ads from her hosting agent page to her own public website 12′, and positions the ads in the vicinity of the favorable references to the camera store and camera model.

When a visitor to the photographer's public website 12′ reads the article and sees the favorable references to the online camera store and to the particular model camera, he might click on the ad for the camera store and the visitor's computer then transmits a URL that redirects the visitor to the online camera store. The URL is also encoded with information identifying the hosting agent, the listing agent and the ad. A bookkeeping system 26 maintained by the referral service host records the click and records the information identifying the hosting agent, the listing agent and the ad. In the event that the tag-and-act interface is used, the tag associated with the ad is updated to reflect that the ad has been clicked. As described in the prior provisional application, the hosting agent may subsequently view the tag and the history of the ad object.

If the visitor clicks on the ad for the camera model recommended by the photographer, the URL associated with that ad redirects the visitor to the particular page in the online camera store that features the particular camera model. As before, the bookkeeping system records the click and information identifying the hosting agent, the listing agent and the ad. Periodically, the bookkeeping system tallies the clicks and sends the listing agent an invoice reflecting the amount due to each hosting agent based on the listing agent's advertising rates and the clicks through from the respective hosting agents' websites to the listing agent's website.

Because the clicks through to a listing agent's public website are based at least in part on the content of the hosting agent's website, rather than simply on where the listing agent's website comes in the list returned by a search engine, one may reasonably expect a higher rate of transaction completion than with other online advertising. Further, a recommendation by a hosting agent who has dealt with the listing agent is more credible to other website visitors than a recommendation by a commercial reviewer.

The referral service host may also operate a search engine that allows hosting agents to search for ads over multiple listing agents. For example, suppose that in the example, the photographer was satisfied with the camera but did not consider the online camera store's service to be particularly good. The photographer might then use the search engine to search for this particular camera without regard to the listing agent and might then select an ad on the basis of the payment terms offered by the different listing agents offering ads for that particular model of camera. Having selected an ad using the search engine, the photographer copies the ad to her hosting agent page and copies the ad to her public website.

The referral service host also supports information resources. Specifically, hosting agents may provide feedback regarding their experiences with different listing agents, and the referral service host may publish listing agent ratings. For example, if a listing agent does not promptly pay the amount due the hosting agent, the hosting agent may report negative feedback regarding the listing agent. In addition, the bookkeeping system accumulates information regarding the click through rate of each ad so that a hosting agent can determine whether the performance of a particular ad on his site is comparable with the performance of the same ad on other sites. In addition, the referral service host supports member contact lists, which allow a listing agent to send messages promoting his ads to hosting agents who have previously opted in to receive such messages.

The referral service may also receive and tabulate feedback from purchasers regarding products and services and this information is available to members who are able to use the information in making decisions regarding purchase of products and services. The search engine may also be accessible without secure login, to visitors other than listing agents and hosting agents. A visitor who is interested in purchasing a particular model of digital camera might enter the manufacturer and model number in the search field to retrieve ads for that particular digital camera. In the case of a visitor who uses the search engine without secure login, the information associated with the ads is not available and the hyperlinks are active. Thus, a visitor who clicks on an ad is redirected to the website of the listing agent who placed the ad on the referral service. In this case, the bookkeeping system records a click through in favor of the referral service. The search engine returns search results based on hosting activity. Thus, if a visitor uses the search engine to search for a product that is offered by several listing agents, the search engine will give precedence in the search result to a listing agent whose ads have been chosen by more hosting agents or who has received favorable feedback reports from hosting agents. The search engine may calculate a weighted sum of various indicators of hosting activity in determining an overall measure of hosting activity.

The hosting agent (the photographer in the case of the example) might also be a listing agent. For example, the photographer might offer photography services or consultation. In this case, the photographer has not only a hosting agent page but also a listing agent page, containing the photographer's ads and associated information. Other hosting agents who have used the photographer's services may select the photographer's ads for inclusion on their websites.

A non-member who wishes to engage the services of a photographer or other service provider may enter an appropriate query (such as “photographer”) in the search field of the search engine and will receive a search result identifying listing agents who meet the query. The search result will favor a listing agent who has a high hosting activity, and, as noted above, one factor that may be used in calculating hosting activity is the number of times the ads of the listing agent have been selected by hosting agents.

The invention has been described above in the context of a host-client service in which there is a central referral service host and the members of the service are clients that interact with the host rather than directly with each other. However, the referral service may be operated as a peer-to-peer network, in which the referrals, invoicing and payment are made directly between members without employing a central host computer. In this case, the search engine would nevertherless typically be operated on a central host computer.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of the claims beyond the literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. Further, unless the context indicates otherwise, the word “comprises” or a derivative thereof requires the stated element or elements but is not intended to exclude the possibility of one or more additional elements. Unless the context indicates otherwise, use of “or” in a claim is not intended to be interpreted exclusively.

1. A method of managing advertising on an Internet website, wherein:
a referral service operates a referral service website including a listing agent interface that allows a listing agent to offer ads for placing on websites and a hosting agent interface that allows a hosting agent to select an ad offered by the listing agent and place the selected ad on the hosting agent's website,
when a visitor to the hosting agent's website activates the listing agent's ad, the referral service records a credit entry to the hosting agent and a debit entry to the listing agent,
the referral service reports the credit and debit entries to the hosting agent and to the listing agent.

2. A method according to claim 1, wherein the listing agent interface is a listing agent page containing a menu of ads offered by the listing agent, the hosting agent interface is a hosting agent page, and the hosting agent may select an ad offered by the listing agent, copy the selected ad to the hosting agent page, and copy the ad from the hosting agent page to the hosting agent's website.

3. A method according to claim 2, wherein the referral service operates a search engine that allows a hosting agent to search listing agent pages for ads.

4. A method of managing advertising on an Internet website by a referral service association including listing agent members and hosting agent members, wherein:
the listing agent members and the hosting agent members operate respective public websites,
the referral service operates a referral service host including listing agent pages allocated to the listing agents respectively,
a listing agent uses the allocated listing agent page to offer ads for placing on hosting agent websites,
a hosting agent selects an ad from the listing agent page and places the selected ad on the hosting agent's public website,
when a visitor to the hosting agent's public website activates the listing agent's ad, the visitor is redirected to the listing agent's public website and the referral service records a credit entry to the hosting agent and a debit entry to the listing agent,
the referral service reports the credit and debit entries to the hosting agent and to the listing agent.

5. A method of managing referrals by a referral service association including listing agent members and hosting agent members, wherein:
the listing agent members operate respective public websites though which each listing agent member offers to enter into contracts for providing goods or services,
the hosting agent members may indicate approval of a listing agent member,
the referral service operates a website with a search engine interface whereby a visitor may enter a query seeking goods or services offered by one or more listing agents, and
in response to a query, the search engine returns a search result in which listing agents that meet the query are identified in order of precedence based on approval by the hosting agent members.
